(19) United States
(12) Patent Application Publication
(10) Pub. No.: US 2023/0087178 A1
(43) Pub. Date: Mar. 23, 2023

(54) SYSTEM AND METHOD FOR EVENT MANAGEMENT

(71) Applicant: DEREK A. SLEDGE, SAN ANTONIO, TX (US)

(72) Inventor: DEREK A. SLEDGE, SAN ANTONIO, TX (US)

(21) Appl. No.: 17/483,096

(22) Filed: Sep. 23, 2021

(51) Int. Cl. G06F 16/955; G06K 19/06; G06Q 10/02

(52) U.S. Cl. CPC G06F 16/9554; G06F 16/9566; G06K 19/06037; G06Q 10/02

(57) ABSTRACT

Events may be managed by a variety of systems, processes, and techniques. In particular implementations, managing events may include receiving event data that is to be displayed on an end user device and generating a display format for the event data to be displayed. Managing events may also include receiving event data that is to be printed, generating a 2D barcode linking to the event data to be displayed, and generating a printer file including the event data to be printed and the 2D barcode. The printer file may be sent to printer that generates a sign including the event data to be printed and the 2D barcode. Managing event may additionally include receiving a request, based on the 2D barcode, for the event data to be displayed and generating a response containing the event data to be displayed.

### TECHNICAL FIELD

This invention relates in general to computerized management of events and, more particularly, to managing events using integrated physical and digital displays.

### BACKGROUND

Events are typically announced through traditional means (e.g., printed invitations sent via mail or printed signs) or electronic means (e.g., e-mails or websites). Whether by traditional means or electronic means, the details of the event (e.g., event type, place, time, etc.) are typically conveyed with the announcement.

In regard to expected attendance, traditional invitations either rely on the invitees to directly respond to the host (e.g., via letter or phone call) or on general estimates of attendance based on the number of invitations and/or past experience. For electronic means, events often rely on responses via a website (e.g., Yes, No, Maybe, No Response) for estimates of attendance.

Printed signs present a much different problem in regard to announcements and expected attendance. In regard to announcements, because a printed sign is typically viewable by the public, personal information (e.g., name, address, age, etc.) should be kept to a minimum, especially if the event involves a minor. Moreover, a host may not want to invite particular people (e.g., people they do not like or strangers to a child's party) to an event. Thus, printed signs are typically not preferred for a personal party. Additionally, there is only so much information that can be placed on a sign and have it be readable. These factors somewhat limit the usefulness of signs for event announcements. And in regard to attendance, it is unknown how many people actually read the signs, and for those that do read them, how many actually care about the event. Thus, past experience is typically the only useful guide to give a ballpark estimate for attendance, which also limits the usefulness of printed signs for events.

### SUMMARY

Events may be managed by a variety of systems, processes, and techniques. In particular implementations, an event management system may, among other things, include a server system and a printer. The server system may receive event data that is to be displayed on an end user device and generate a display format (e.g., a webpage) for the event data to be displayed. The server system may also receive event data that is to be printed, generate a 2D barcode linking to the event data to be displayed, and generate a printer file including the event data to be printed and the 2D barcode. The printer may receive the printer file from the server system and generate a sign including the event data to be printed and the 2D barcode. The server system may additionally receive a request, based on the 2D barcode, for the event data to be displayed and generate a response containing the event data to be displayed. The 2D barcode may, for example, encode a Uniform Resource Locator.

In certain implementations, the server system may generate a webpage containing the event data to be displayed and send the webpage in response to receiving a request for the event data to be displayed.

In particular implementations, the server system may receive responses to the displayed event data. The displayed event data may, for example, include response requests, and the server system may receive a response request and associate it with the displayed event data.

In some implementations, event data to be printed may have less data content than the event data to be displayed. For example, the event data to be printed may have less than 10 percent of the data content of the event data to be displayed.

Additionally, the data content overlap between the event data to be printed and the event data to be displayed may be less than 10 percent. In particular implementations, in fact, there is no overlap in data content between the event data to be printed and the event data to be displayed.

In certain implementations, the server system may, in response to a request for the event data to be displayed, generate a response containing a portion of the event data to be displayed and asking for personal data from an end user associated with the request. The server system may also receive a response containing personal data from an end user, determine whether the personal data is valid, and generate a response containing the rest of the event data to be displayed if the personal data is valid.

A process for event management may include receiving event data that is to be displayed on an end user device and event data that is to be printed. The process may also include generating a display format for the event data to be displayed, a 2D barcode linking to the event data to be displayed, and a printer file including the event data to be printed and the 2D barcode. The process may additionally include sending the printer file to a printer that generates a sign including the event data to be printed and the 2D barcode. The process may further include receiving a request, based on the 2D barcode, for the event data to be displayed and generating a response containing the event data to be displayed.

To generate a response containing the event data to be displayed, the process may include generating a webpage containing the event data to be displayed and sending the webpage in response to receiving a request for the event data to be displayed.

In certain implementations, the displayed event data may include response requests. In these implementations, the process may further include receiving responses to the displayed event data and associating it with the displayed event data.

The event data to be printed may have less data content that than the event data to be displayed. For example, the data content of the event data to be printed may be less than 10 percent of the data content of the event data to be displayed.

Additionally, the data content overlap between the event data to be printed and the event data to be displayed may be less than 10 percent. And in particular implementations, there is no overlap in data content between the event data to be printed and the event data to be displayed.

The process may also include generating, in response to a request for the event data to be displayed, a response containing a portion of the event data to be displayed and asking for personal data from an end user associated with the request. The process may also include receiving a response containing personal data from an end user, determining whether the personal data is valid, and generating a response containing the rest of the event data to be displayed if the personal data is valid.

Various implementations may have one or more features. For example, an event management system and/or process may allow printed signs to be used to make announcements regarding events that require more data than can be normally printed on a sign. Although the signs may not directly present all of the event data, they can provide an automated way in which to retrieve additional event data. As another example, although the event data may be sensitive, the announcement can still be public. Sensitive data may, for example, have security features to prevent its automated retrieval. As a further example, event announcements via signs may provide a way for attendance to be monitored (e.g., based on a guest list).

Many other features will be evident from the remainder of this application in light of a more exhaustive understanding of the numerous difficulties and challenges faced by the prior art, which in turn will be evident to those skilled in the art.

### BRIEF DESCRIPTION OF THE DRAWINGS

For a more complete understanding of the present invention and its implementations, and the features thereof, reference is now made to the following descriptions taken in conjunction with the accompanying drawings, in which:

FIG. 1 is block diagram illustrating selected components of an example system for event management.

FIG. 2 is a line drawing illustrating an example user interface generated by an event management system.

FIG. 3 is a line drawing illustrating another example user interface generated by an event management system.

FIG. 4 is a line drawing illustrating an additional example user interface generated by an event management system.

FIG. 5 is a line drawing illustrating a further example user interface generated by an event management system.

FIG. 6 is a flow diagram illustrating selected operations for an event management process.

FIG. 7 is a flow diagram illustrating selected operations for an additional event management process.

FIG. 8 is a block diagram illustrating selected components of an example computer system for use in an event management system.

Like reference numerals are used for similar elements of various embodiments.

### DETAILED DESCRIPTION

While the inventive concepts are much more basic than any particular implementation, one skilled in the art can gather a partial appreciation for some of the possible benefits of the broader concepts and possible interplay between various elements of the concepts in the course of considering example implementations, some of which are described in detail below.

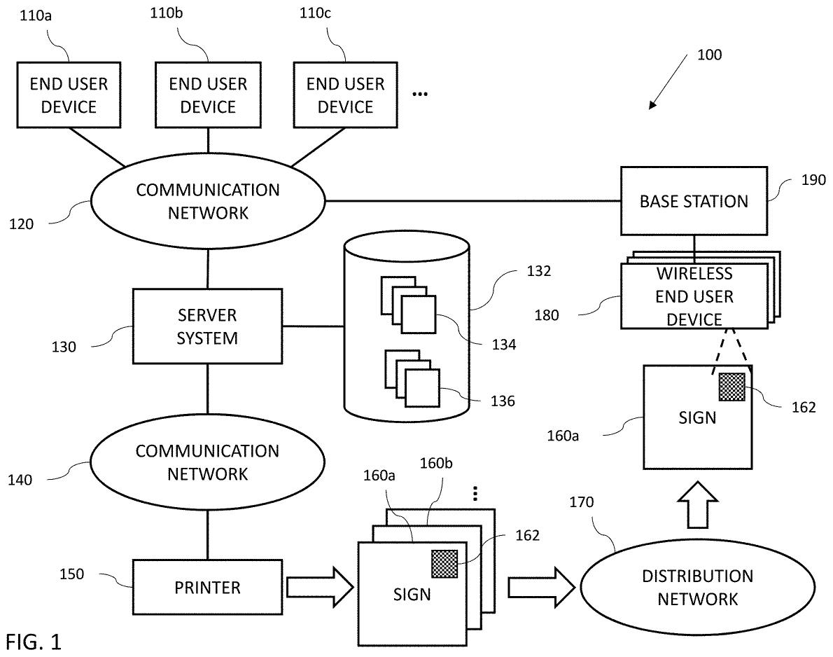

FIG. 1 illustrates selected components of an example event management system 100. In general, system 100 may be used to generate two types of data regarding an event—printed data and electronically displayed data. System 100 may also be used to manage data regarding event invitees.

System 100 includes a number of end user devices 110 through which end users (i.e., people) may enter data regarding an event (e.g., description, time, date, place, invitees, etc.). End user devices 110 may generally be any computerized device. For example, end user devices 110 may be personal computers, laptops, tablets, or smart phones.

End user devices 110 are at least communicatively coupled to a communication network 120. Physical coupling may, for example, occur via cables, phone lines, and/or optical links. Wireless coupling may, for example, occur via IR, WiFi, cellular, or satellite links.

Communication network 120 may be a local area network and/or a wide area network. In particular implementations, communication network 120 may include the Internet. In certain implementations, communication network 120 may include a variety of different networks (e.g., a local area network, a wide area network, the Internet, a cellular network, and/or the Public Switched Telephone Network (PSTN)).

Also communicatively coupled to communication network 120 is a server system 130. As illustrated, server system 130 includes a database 132. Server system 130 may be an individual server of a group of servers (whether co-located or distributed). Server system 130 may have a physical location or be in the cloud.

Database 132 includes event data, which can categorized as event data to be displayed 134 and event data to be printed 136 for various events. In simple terms, event data to be displayed 134 is data about the event that will actually be displayed on an end user device (to be discussed in more detail later), and event data to be printed is 136 is data regarding the event that will actually be printed (e.g., on a sign). Event data to be displayed 134 and event data to be printed may contain overlapping data or may contain no overlapping data. And although shown as separate files, the event data to be printed and the event data to be printed for an event may be in the same file in certain implementations.

Server system 130 is at least communicatively coupled to a communication network 140. Communication network 140 may, for be a local area network or a wide area network. In particular implementations, communication network 140 may include the Internet. In certain implementations, communication network 120 and communication network 140 may be the same communication network.

Also coupled to communication network 140 is a printer 150. Printer 150 may, for example, be a laser printer, an ink jet printer, a screen printer, a plotter, a sublimation printer, a UV printer, a latex printer, or any other appropriate type of printer. In general, printer 150 is able to receive a file to be printed from server system 130 and produce one or more signs 160, which may be made of paper, vinyl, plastic, metal, cardstock, or any other appropriate medium. In particular implementations, a sign may be made of corrugated plastic.

On each sign is a set of data to be printed (e.g., from one files 136). Also on each sign is a 2D barcode 162. The 2D barcode encodes data (e.g., instructions and/or addresses) for linking to the data to be displayed for the event (e.g., in a file 136). The 2D barcode is typically generated by the server system 130 and included in the data sent to printer 150. The 2D barcode may, for example, be a Quick Response (QR) code that encodes instructions for accessing the data to be displayed. The access could, for example, occur via File Transfer Protocol (FTP), Hypertext Transfer Protocol (HTTP), or any other protocol accessing data through a communication network.

Signs 160 are physically distributed through a distribution network 170. Distribution network 170 may, for example, be the United States Postal Service or a private carrier (e.g., FedEx). Signs 160 are typically sent to a small number of sites (maybe even one) and then individually placed at different locations in an area (e.g., in a neighborhood or city).

System 100 also includes wireless end user devices 180 (e.g., smart phones or tablets) that can scan and decode the 2D barcode 162 on signs 160. Wireless end user devices 180 are linked to a base station 190 (e.g., a wireless modem or a cellular tower), which allows access to communication network 120. In some implementations, base station 190 may actually be part of communication network 120. By scanning the 2D barcode 162, wireless end user device 180 may retrieve the event data to be displayed and display the data. In particular implementations, wired end user devices could also read the signs 160.

In certain modes of operation, when an end user wants to use system 100 to manage an event, she accesses one of end user devices 110, such as end user device 110a. End user device 110a contacts server system 130 through communication network 120, and server system 130 providers services to end user device 130 (e.g., by entering into a client-server relationship with end user device 110a).

Server system 130 may, for example, request event data to be displayed from the end user. To accomplish this, server system 130 may, for instance, send a template to the end user device 110a for display to the end user and receipt of event data from the end user. In other implementations, the user may enter the data in free form.

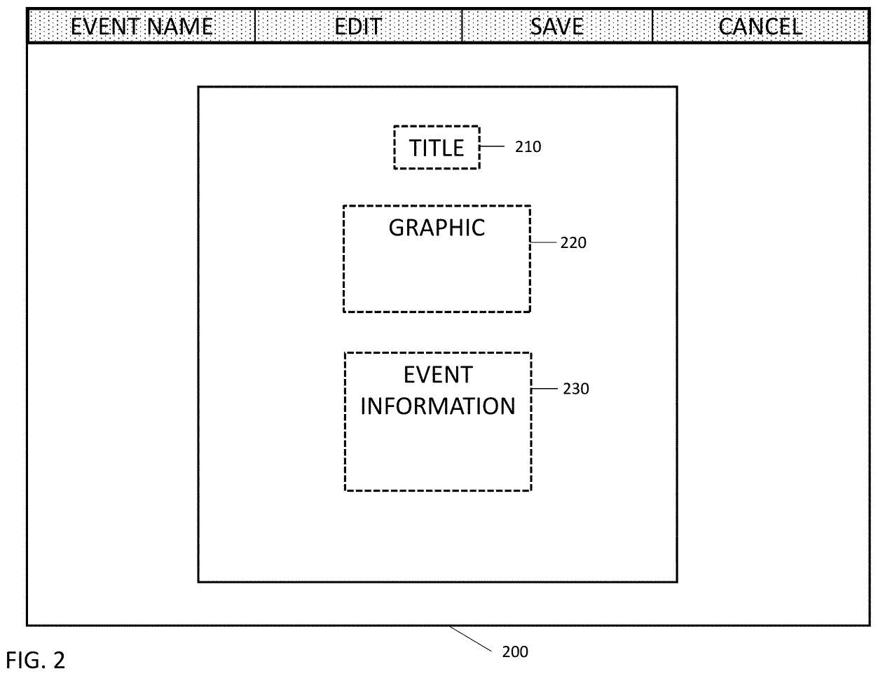

FIG. 2 illustrates an example template 200 for receiving data to be displayed from end user device 110a. As illustrated, template 200 includes a title section 210, a graphic section 220, and an event data section 230. The end user may enter data through end user device 110a into each section. The data may be in textual and/or graphic form. In certain implementations, the end user may choose from various template formats and/or rearrange the format of a template.

Template 200 is only an example template. Various other template formats may be used.

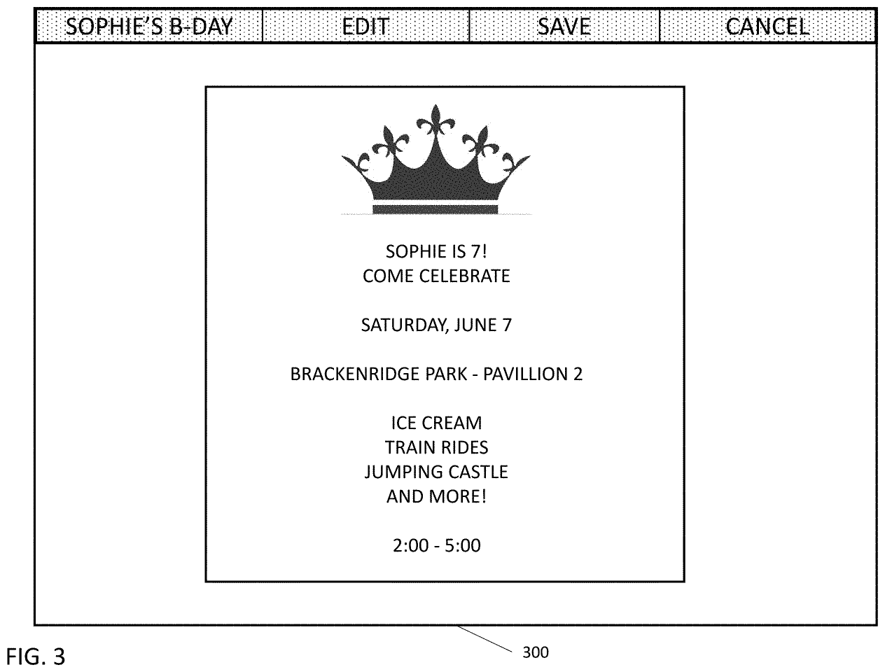

FIG. 3 illustrates an example of a completed template 300 for receiving data to be displayed from an end user. In template 300, a user has named the event and entered event data. As mentioned above, template 300 includes graphic and textual data. Once the end user has completed a template, she may activate the save button, and the finalized template data may be conveyed to server system 300, where it is stored in database 132 as event data to be displayed 134. The event data to be displayed may be converted into a display format such as a file (e.g., a PDF) or a webpage (e.g., a landing page) by server system 130.

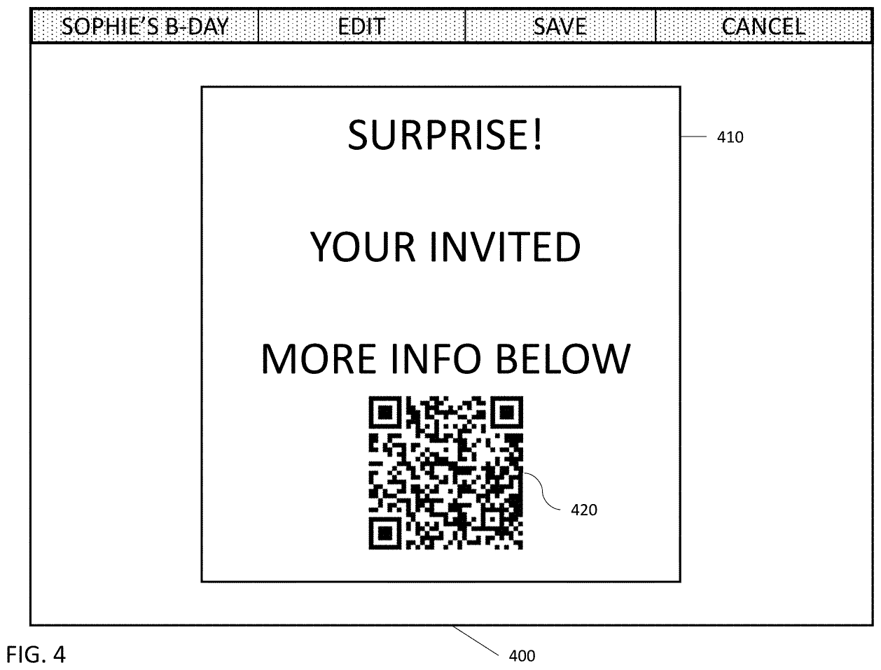

FIG. 4 illustrates an example template 400 for event data to be printed. As shown in template 400, a user has entered data 410 regarding the event, here only being a vague announcement that an event is occurring. In other implementations, the end user may enter additional event data if she likes.

Also included in template 400 is a 2D bar code 420. 2D bar code 420 is generated by server system 130 and placed in the printed event data. 2D bar code 420 provide instructions for an end user device to link to the event data to be displayed (or a display format thereof), which is stored in database 132. 2D bar code 420 may be moved and/or resized by the end user. Once the end user has completed the template, they may activate the save button, and the finalized template data may be conveyed to server system 130, where it is stored in database 132 as printed event data 136.

Template 400 is only an example template. Various other template formats may be used.

The amount of data content, which includes the data and the contextual use of it, between the event data to be printed and the event data to be displayed may vary drastically. For example, the total data content of the event data to be printed may be less than 50% of the event data to be displayed, and in some implementations may be less than 25%, or even less than 10%, as shown in FIG. 3 versus FIG. 4. In other implementations, that amount of data or information content may be used in comparing data to be printed to event data to be displayed.

Additionally, the amount of overlapping data content (i.e., data content that is the same) may be small. For example, the amount over overlapping data content may be less than 25%, and in some implementations may be less than 10%, or even 0%, as shown in FIG. 3 versus FIG. 4.

Once a template such as template 400 is completed, server system 130 may generate a file for printer 150 containing the event data to be printed, including the 2D barcode. The file may, for example, be a vector file (e.g., a PDF), a raster file (e.g., a JPG), or any other appropriate file format. Server system 130 may then send the file through communication network 140 to printer 150, which may print the event data to be printed on one or more signs 160.

Signs 160 may then be physically sent through distribution network 170. The signs may go to one or more locations and then be distributed to locations associated with invitees (e.g., at their home, at their place of business, or around a neighborhood).

An invitee may then use their wireless end user device 180 to scan 2D bar code 162. The wireless end user device may decode the 2D bar code, which provides instructions for linking to the associated event data to be displayed 136. The wireless end user device may then send a request for the event data to be displayed to server system 130 through communication network 120.

Upon receiving a request for event data to be displayed, server system 130 may return the event data to be displayed (e.g., as a file or a webpage), and wireless end user device 180 may present the event data to be displayed to a user.

In particular implementations, the event data to be displayed 136 may be formatted into a webpage by server system 130. The webpage may be static or formed on request. The webpage, in the form of HTML, CSS, and Javascript commands, for example, may be sent to wireless end user device 180, which may construct the webpage. In some implementations, server system 130 may construct the webpage.

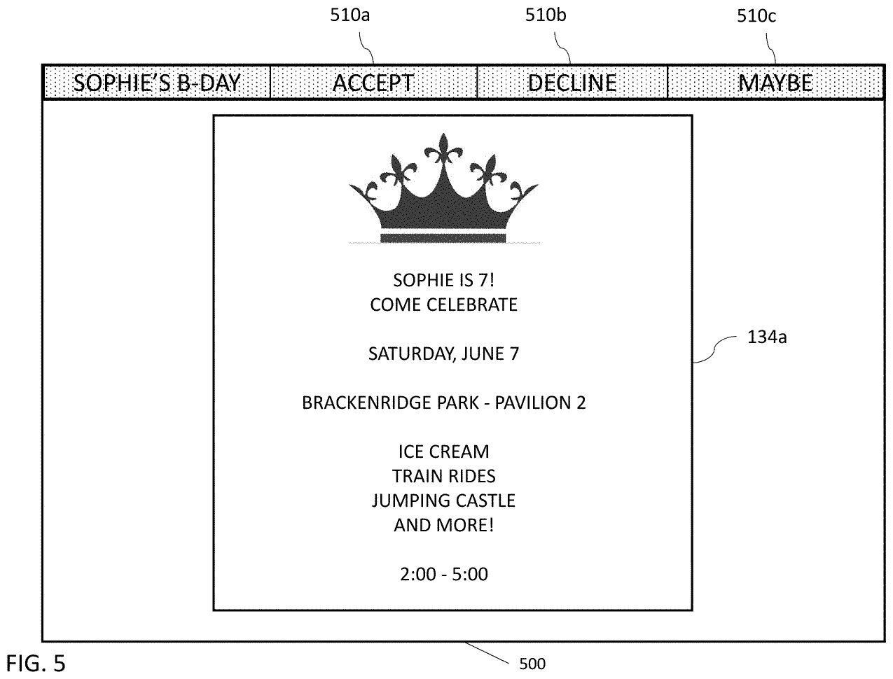

FIG. 5 illustrates an example webpage 500 containing event data to be displayed. In this implementation, the event data to be displayed matches that entered in template 300. In other implementations, the webpage does not have to exactly match the template.

Webpage 500 also allows the user of end user device 180 to RSVP for the event—using buttons 510. This feature may be used in certain implementations.

In certain modes of operation, event data to be displayed may be considered sensitive data (e.g., if it involves personally identifying data regarding a minor). At the time of entering the data, the end user generating the event data may be asked for the age of the person for whom the event is being held and/or the location of the event. If the person for whom the event is being generated is young (e.g., under 13) and/or the event is being held at a person's residence, security procedures may be implemented regarding presenting the event data to be displayed, to be discussed in more detail below. In certain implementations, the person creating the event may opt out of the security procedures if they verify that they are an adult.

System 100 has a variety of features. For example, system 100 allows printed signs to be used to make announcements regarding events that require more data than can be normally printed on a sign. Moreover, the event data may be sensitive, but the announcement can still be public. Although the signs do not directly present the sensitive data, they provide an automated way in which to retrieve the data. Moreover, sensitive data may have security features to prevent its automated retrieval. Furthermore, additional data to that which can be placed on a sign can be presented in the automated manner. Additionally, event announcements via signs system 100 may provide a way for attendance to be monitored (e.g., based on a guest list).

Although system 100 has been discussed in the context of an invitation to an event, system 100 may have applicability in a variety of other cases. For example, system 100 may be useful for life announcements, home sales, Homeowners Association (HOA) meetings, and political campaigns.

Life announcements could, for example, proclaim almost any significant life event, such as a graduation (e.g., from high school), a promotion, or a new baby. The sign might say something as simple as “Congratulations” or “Announcement”, but it could also have further information, like the person of interests name and/or information about the life event. System 100 would continue to generate a 2D barcode for inclusion on the sign, and the barcode could be scanned for more information on the life event (e.g., on a landing page). The additional information could, for example, include a biography and/or video message about the person and/or event. In particular implementations, the additional information could include financial assistance information (e.g., Venmo or preferred gift cards), or a gift registry. An RSVP system may, however, not be needed.

Realtors may use system 100 for generating real estate listing signs. Each real estate company (e.g., Keller Williams) has particular sign requirements, and a template could be created for the realtors for a company. A realtor could, for example, create a sign that could be placed in front of a house for sale. The sign could provide basic information—e.g., “For Sale” and the realtor's name. A relator could be assigned a number of 2D barcodes that could each be reused. A 2D barcode would be printed on the sign and would link to a web page that would give more information regarding the house and, potentially, allow a person to make appointments to see the house. The web page could be updated when the sign is used at another house.

System 100 could also be used by a Homeowner's Associations (HOA). For example, an HOA could have signs made with its name, a 2D barcode, and announcement (e.g., “Upcoming Meeting”). The signs could then be distributed around the neighborhood to notify homeowners of an upcoming event. The 2D barcode would link to a web page that would give more information about the event. In particular implementations, the web page could also allow homeowners to RSVP for the event so that the HOA can plan appropriately. If need be, security can be provided by having the person performing a scan enter information (e.g., name, address, phone number, etc.) that can be cross-referenced against a directory before accessing the event data. The signs could be reused for subsequent events by updating the web page.

Additionally, system 100 could be used by politicians. In this case, a campaign sign could be printed with a 2D barcode that would link to a web page. The web page could provide biographical information and/or allow contributions (e.g., via Venmo or Paypal).

Although FIG. 1 illustrates and example system 100 for event management, other systems for event management could include fewer, additional, and/or a different arrangement of components. For example, communication network 120 and communication network 140 could be the same network. As another example, a system may not include a distribution network. For example, an end user may pick the signs up from the printer and distribute them herself.

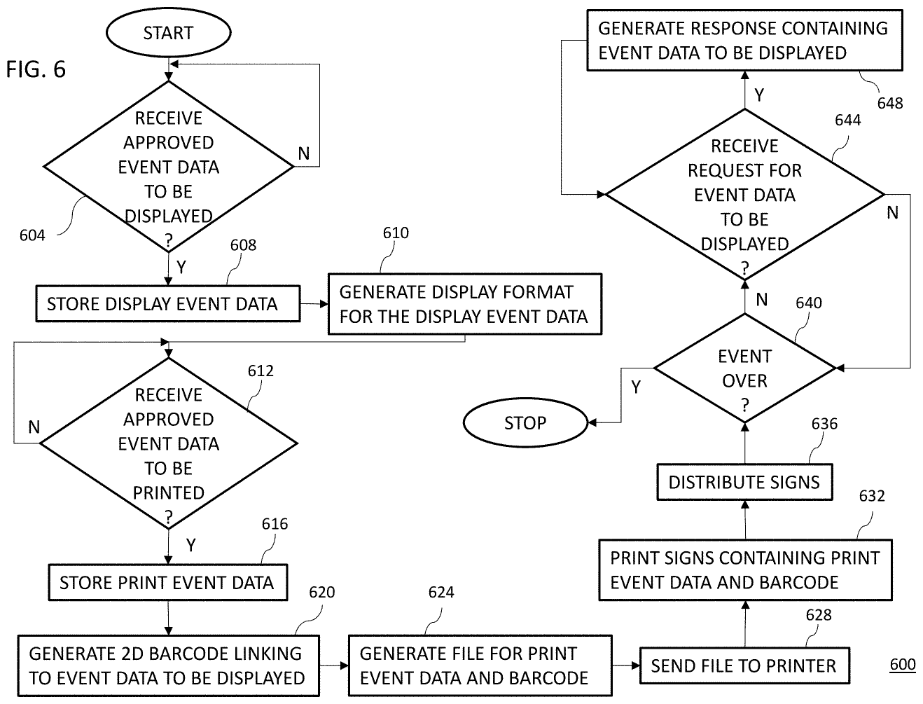

FIG. 6 illustrates selected operations of an example process 600 for managing an event. Process 600 could, for example, be implemented by a system similar to system 100.

Process 600 calls for waiting to receive approved event data to be displayed (operation 604). This data typically comes from an end user device (e.g., a personal computer) through which an end user may enter regarding an event (e.g., description, time, date, place, invitees, etc.). The event data is approved once a user chooses to save it.

Once approved event data to be displayed has been received, process 600 calls for storing the approved event data (608). This data may, for example, be placed in a database. Note that the display event data may have been stored before this point (e.g., as the user is entering it), but there is also a storage event that happens once the event data is approved.

Process 600 also calls for generating a display format for the event data (operation 610). The display format may, for example, be a file type (e.g. PDF), a webpage (e.g., a landing page), or any other appropriate display format the may be communicated electronically to a remote end user device.

Process 600 also calls for waiting to receive approved event data to be printed (operation 612). This data typically comes from an end user device through which an end user may enter data regarding the event. Displayed event data 134 and printed event data may contain overlapping data content or may contain no overlapping data content.

Once approved event data to be printed has been received, process 600 calls for storing the approved event data (operation 616). This data may, for example, be placed in a database. Note that the event data to be printed may have been stored before this point (e.g., as the user is entering it), but there is also a storage event that happens once the event data is approved.

Process 600 additionally calls for generating a 2D barcode (e.g., a QR code) linking to the event data to be displayed (operation 620). The 2D barcode encodes instructions for linking to the data to be displayed. The event data to be displayed may, for example, be stored as a displayable file (e.g., a PDF), converted into a webpage (e.g., a landing page), or any stored in any other format that may be displayed on a user device.

Process 600 further calls for generating a file including the print event data and the 2D barcode (operation 624). The file may for, example, be a vector file. The file is sent to a printer through a communication network (operation 628). The communication network may, for example, be a local area network or a wide area network.

Once the file has been sent to the printer, process 600 calls for printing signs containing the event data to be printed and the 2D barcode (operation 632). The printing may, for example, be accomplished by a UV printer on corrugated plastic.

Process 600 also calls for distributing the signs (operation 636). The signs may, for example, be delivered through a private carrier (e.g., to the user that created the event) and then individually placed at different locations in an area (e.g., peoples' houses).

Process 600 also calls for determining whether the event is over (process 640). Determining whether the event is over may, for accomplished, based on the time for the event passing or the event being cancelled. If the event is over, process 600 is at an end.

If, however, the event is not over, process 600 calls for determining whether a request for event data to be displayed has been received (operation 644). If a request for event date to be displayed has not been received, process 600 calls for again checking whether the event is over. But if a request for event data has been received, process 600 calls for generating a response containing the event data to be displayed (operation 648). The response may, for example, be in the form of a webpage, which may have been previously generated.

Process 600 then calls for again checking for a request for event data to be displayed. If a request is received, process 600 calls for again displaying the event data to be displayed.

Although FIG. 6 illustrates an example process for event management, other processes for event management may include fewer, additional, and/or a different arrangement of operations. For example, receiving the approved event data to be printed may be accomplished before receiving the approved event data to be displayed. Additionally, event data may be stored simultaneously with it being received. As an additional example, the 2D barcode may be generated at various points in the process or generated beforehand. As another example, a security feature may be implemented before generating a response containing event data to be displayed.

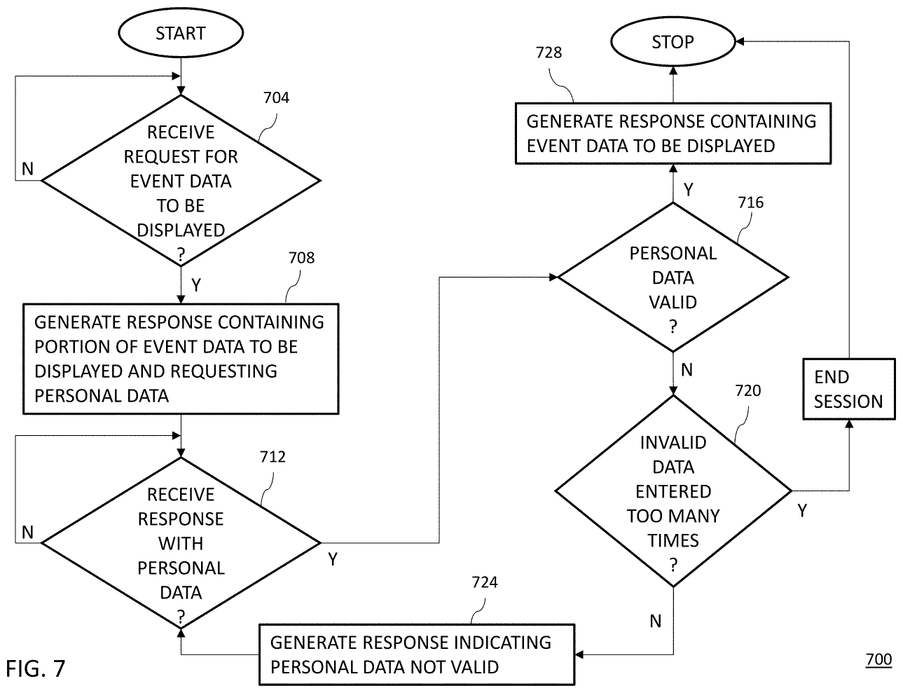

FIG. 7 illustrates selected operations of an example process 700 for managing an event. Process 700 could, for example, be implemented by a system similar to system 100 and used in a process similar to process 600.

Process 700 calls for determining whether a request for event data to be displayed has been received (operation 704). Such a request may, for example, come from an end user device that has scanned a 2D barcode on a sign. If a request for event data to be displayed has been received, process 700 calls for generating a response containing a portion of the event data to be displayed and requesting personal data from the end user (operation 708). The personal data could, for example, be data regarding the person for whom the event is for (e.g., last name, school, nickname, phone number, etc.), a person invited to the event (e.g., first name, school, nickname, phone number, etc.), which could be the end user, or some other person (e.g., the person who planned the event).

Process 700 also calls for determining whether a response with personal data has been received (operation 712). If a response with personal data has been received, process 700 calls for determining whether the personal data is valid (operation 716). Determining whether the personal data is valid may, for example, be accomplished by comparing the received personal data against a database of personal data, which may have been created when the event data was entered.

If the personal data is not valid, process 700 calls for determining whether invalid data has been entered too many times (operation 720). If invalid data has been entered too many times (e.g., 3), process 700 calls for ending the session. If, however, personal data has not been entered too many times, process 700 calls for generating a response indicating that the personal data is not valid (operation) 724) and awaiting to receive a response containing personal data (operation 712).

If, however, the personal data is valid, process 700 calls for generating a response containing event data to be displayed (operation 728). The event data to be displayed may then be presented on an end user device.

The flowchart and block diagrams in the figures illustrate the architecture, functionality, and operation of systems, methods, and computer program products of various implementations of the disclosure. In this regard, each block in the flowchart or block diagrams may represent a module, segment, or portion of code, which can include one or more executable instructions for implementing the specified logical function(s). It should also be noted that, in some alterative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or the flowchart illustration, and combination of blocks in the block diagrams and/or flowchart illustration, can be implemented by special purpose hardware-based systems the perform the specified function or acts, or combinations of special purpose hardware and computer instructions.

As will be appreciated by one skilled in the art, aspects of the present disclosure may be implemented as a system, method, or computer program product. Accordingly, aspects of the present disclosure may take the form of an entirely hardware environment, an entirely software embodiment (including firmware, resident software, micro-code, etc.), or an implementation combining software and hardware aspects that may all generally be referred to herein as a “circuit,” “module,” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this disclosure, a computer readable storage medium may be a tangible medium that can contain or store a program for use by or in connection with an instruction execution system, apparatus, or device.

A computer readable signal medium may include a propagated data signal with computer readable program code embodied therein, for example in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any medium, including but not limited to wireless, wireline, optical fiber cable, RF, etc. or any suitable combination of the foregoing.

Computer program code for carrying out operations for aspects of the disclosure may be written in any combination of one or more programming languages such as Java, Smalltalk, C++ or the like and conventional procedural programming languages, such as the “C” programming language or similar programming languages. The program code may execute entirely on the end user's device, partly on the end user's device, as a stand-alone software package, partly on the end user's device and partly on a remote computer (e.g., server system), or entirely on the remote computer. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the disclosure are described above with reference to flowchart illustrations and/or block diagrams of methods, apparatus (systems), and computer program products according to implementations. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other device to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions that execute on the computer or other programmable apparatus provide processes for implementing the functions/acts specified in the flowchart and/or block diagram block or blocks.

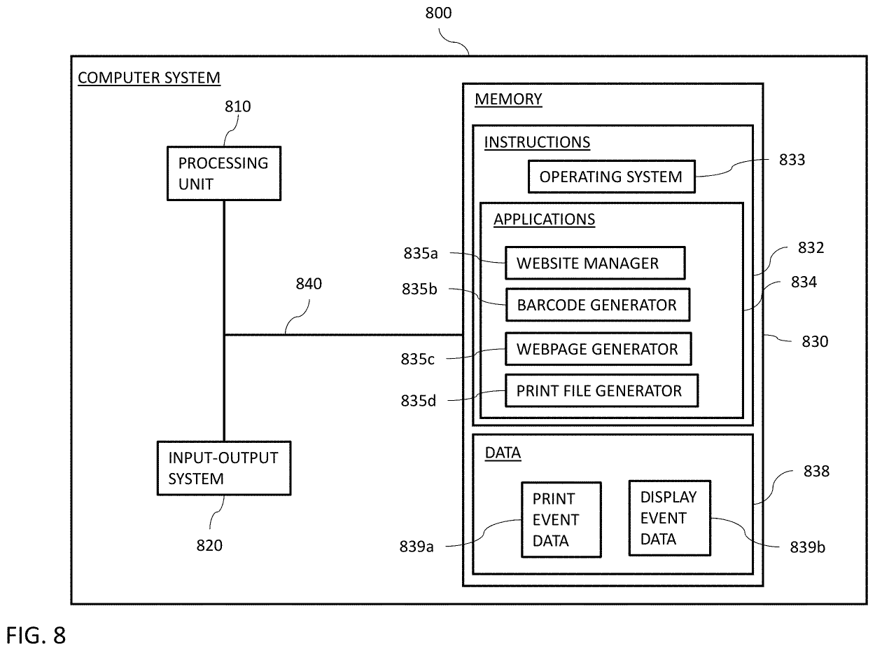

FIG. 8 illustrates selected components of an example computer system 800 for event management. System 800 may, for example, be part of a system similar to system 100 (e.g., a server system). System 800 includes a processing unit 810, an input-output system 820, and memory 830, which are coupled together by a network system 840.

Processing unit 810 may, for example, include one or more microprocessors, which could, for instance, operate according to reduced instruction set computer (RISC) or complex instruction set computer (CISC) principles. Processing unit 810 may operate according to instructions stored in memory 830 and/or encoded on processing unit 810 itself. In general, processing unit 810 may be any device that manipulates information in a logical manner.

Input-output system 820 may, for example, include one or more communication interfaces and/or one or more user interfaces. A communication interface may, for instance, be a network interface card (whether wireless or wireless) or a modem. A user interface could, for instance, include one or more user input devices (e.g., a keyboard, a keypad, a touchpad, a stylus, a mouse, or a microphone) and/or one or more user output devices (e.g., a monitor, a display, or a speaker). In general, input-output system 820 may include any combination of devices by which a computer system can receive and output information.

Memory 830 may, for example, include random access memory (RAM), read-only memory (ROM), and/or disc memory (e.g., electronic or optical). Various items may be stored in different portions of the memory at various times. Memory 830, in general, may be any combination of devices for storing information.

Memory 830 includes instructions 832 and data 838. As illustrated, instructions 832 are for an event management server system, which may be centralized or decentralized, but computer systems similar to computer system 800 may be used for controlling various aspects of an event management system.

Instructions 832 include an operating system 833 (e.g., Windows, Linux, or Unix) and one or more applications 834. In this implementation, applications 834 include a website manager 835a, which may manage requests and responses for event data, a bar code generator 835, which may generate 2D barcodes linking to event data to be displayed, a webpage generator 835c for generating a webpage containing the event data to be displayed, and a print file generator 835d for generating a print file containing the information to be printed and a 2D bar code linking to the event data to be displayed. Among other things, data 838 includes event data to be printed 839a and event data to be displayed 839b.

Network system 840 is responsible for communicating information between processor 810, input-output system 820, and memory 830. Network system 840 may, for example, include a number of different types of busses (e.g., serial and parallel).

In certain modes of operation, computer system 800 may receive event data to be displayed and event data to be printed and store the data. The data typically comes from an end user device communicating through a communication network into input-output system. The event data to be displayed may be converted into display format (e.g., a file or a webpage). Displayed event data and printed event data may contain overlapping data or may contain no overlapping data.

Computer system 800 may also generate a 2D barcode (e.g., a QR code) linking to the event data to be displayed. The 2D barcode encodes instructions for linking to the data to be displayed. The event data to be displayed may, for example, be stored as a displayable file (e.g., a PDF), converted into a webpage (e.g., a landing page), or any stored in any other format that may be displayed on a user device.

Computer system 800 also generates a file including the event data to be printed and the 2D barcode. The file may for, example, be a vector file. The file is then sent to a printer through a communication network.

Computer system 800 may also determine whether a request for event data to be displayed has been received. If a request for event date to be displayed has been received, computer system 800 generates a response containing the event data to be displayed. The response may, for example, be in the form of a webpage.

Processing unit 810 may additionally implement any other operations discussed herein. Moreover, computer system 800 may implement any of the other procedures discussed herein, to accomplish these operations.

The terminology used herein is for the purpose of describing particular implementations only and is not intended to be limiting. As used herein, the singular form “a”, “an”, and “the” are intended to include the plural forms as well, unless the context clearly indicates otherwise. It will be further understood that the terms “comprises” and/or “comprising,” when used in the this specification, specify the presence of stated features, integers, steps, operations, elements, and/or components, but do not preclude the presence or addition of one or more other features, integers, steps, operations, elements, components, and/or groups therefore.

The corresponding structure, materials, acts, and equivalents of all means or steps plus function elements in the claims below are intended to include any structure, material, or act for performing the function in combination with other claimed elements as specifically claimed. The description of the present implementations has been presented for purposes of illustration and description, but is not intended to be exhaustive or limited to the implementations in the form disclosed. Many modifications and variations will be apparent to those of ordinary skill in the art without departing from the scope and spirit of the disclosure. The implementations were chosen and described in order to explain the principles of the disclosure and the practical application and to enable others or ordinary skill in the art to understand the disclosure for various implementations with various modifications as are suited to the particular use contemplated.

A number of implementations have been described for event management, and several others have been mentioned or suggested. Moreover, those skilled in the art will readily recognize that a variety of additions, deletions, modifications, and substitutions may be made to these implementations while still achieving event management. Thus, the scope of the protected subject matter should be judged based on the following claims, which may capture one or more concepts of one or more implementations.

1. An event management system, the system comprising:
a server system comprising an electronic processor, the server system configured to:
receive event data that is to be displayed on an end user device;
generate a display format for the event data to be displayed;
receive event data that is to be printed;
generate a 2D barcode linking to the event data to be displayed;
generate a printer file including the event data to be printed and the 2D barcode;
receive a request, based on the 2D barcode, for the event data to be displayed; and
generate a response containing the event data to be displayed; and
a printer configured to receive the printer file from the server system and generate a sign including the event data to be printed and the 2D barcode.

2. The event management system of claim 1, wherein the display format is a webpage.

3. The event management system of claim 2, wherein the server system is configured to generate a webpage containing the event data to be displayed and send the webpage in response to receiving a request for the event data to be displayed.

4. The event management system of claim 1, wherein the 2D barcode encodes a Uniform Resource Locator.

5. The event management system of claim 1, wherein the server system is configured to receive responses to the displayed event data.

6. The event management system of claim 5, wherein the displayed event data includes response requests, and the server system is configured to receive a response request and associate it with the displayed event data.

7. The event management system of claim 1, wherein the event data to be printed has less than 10 percent of the data content of the event data to be displayed.

8. The event management system of claim 1, wherein the data content overlap between the event data to be printed and the event data to be displayed is less than 10 percent.

9. The event management system of claim 8, wherein there is no overlap in data content between the event data to be printed and the event data to be displayed.

10. The event management system of claim 1, wherein the server system, in response to a request for the event data to be displayed, is configured to generate a response containing a portion of the event data to be displayed and asking for personal data from an end user associated with the request.

11. The event management system of claim 10, wherein the server system is further configured to receive a response containing personal data from an end user, determine whether the personal data is valid, and generate a response containing the rest of the event data to be displayed if the personal data is valid.

12. The event management system of claim 1, wherein the sign is composed of corrugated plastic.

13. A method for event management, the method comprising:
receiving, at an electronic server system, event data that is to be displayed on an end user device and event data that is to be printed;
generating, in an automated manner, a display format for the event data to be displayed, a 2D barcode linking to the event data to be displayed, and a printer file including the event data to be printed and the 2D barcode;
sending the printer file to a printer that generates a sign including the event data to be printed and the 2D barcode; and
receiving, at the electronic server system, a request, based on the 2D barcode, for the event data to be displayed and generating a response containing the event data to be displayed.

14. The method of claim 13, wherein generating a response containing the event data to be displayed comprises generating a webpage containing the event data to be displayed and sending the webpage in response to receiving a request for the event data to be displayed.

15. The method of claim 13, wherein the displayed event data includes response requests, and further comprising receiving responses to the displayed event data and associating it with the displayed event data.

16. The method of claim 13, wherein the event data to be printed has less than 10 percent of the data content of the event data to be displayed.

17. The method of claim 13, wherein the data content overlap between the event data to be printed and the event data to be displayed is less than 10 percent.

18. The method of claim 17, wherein there is no overlap in data content between the event data to be printed and the event data to be displayed.

19. The method of claim 13, further comprising, in response to a request for the event data to be displayed, generating a response containing a portion of the event data to be displayed and asking for personal data from an end user associated with the request.

20. The method of claim 19, further comprising receiving a response containing personal data from an end user, determining whether the personal data is valid, and generating a response containing the rest of the event data to be displayed if the personal data is valid.
